(19) United States
(12) Patent Application Publication
(10) Pub. No.: US 2006/0237036 A1
(43) Pub. Date: Oct. 26, 2006

(54) Fill level control system for an article cleaning apparatus

(75) Inventors: John Patrick Picardat, Greenwood, MS (US); David Clinton Weaver, Greenwood, MS (US); Jerry Wayne Ferguson, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/113,699

(22) Filed: Apr. 25, 2005

(51) Int. Cl. B08B 3/02

(52) U.S. Cl. 134/18; 134/25.2; 134/26; 134/56 R; 134/113; 134/184

(57) ABSTRACT

A fill level control system for an article cleaning apparatus is provided. The fill level control system uses a sensor array to monitor a plurality of fill level points within, for example, a dishwasher. The level of water for each wash phase is monitored as a function of its height above the sump of an article cleaning apparatus, and the liquid used in the washing apparatus is introduced as a function of signals produced giving the level of liquid. The fill level control system further includes a low level sensor that turns the pumping system for the article cleaning apparatus off when the sump portion has been completely emptied. A further aspect of the fill level control system is an optional temperature control sensor, integrated with the liquid level sensors, to provide signals for modifying the temperature within the article cleaning apparatus.

### FIELD OF THE INVENTION

This invention generally relates to a fill level control system that may be used with a device to clean articles.

### BACKGROUND OF THE INVENTION

The control program used by dishwashers to clean a load of dishes is commonly referred to as a wash cycle. A wash cycle is made up of multiple wash phases. Each wash phase begins when a fresh charge of water is drawn into the machine and ends when that charge of water, after being circulated throughout the wash system and used to at least partially clean the dishes, is pumped out of the dishwasher. The number of wash phases required to clean a load of dishes can vary greatly, depending on the efficiency of the filtration system, the amount and type of soil on the dishes, and other factors. Some wash cycles can use as many as ten or more wash phases.

The most common method used to control the fill volume for each wash phase of a wash cycle in a domestic dishwasher is a timed fill. Because of unknown conditions during use of the dishwasher, such as line water pressure, variation in plumbing connections and components, and tolerances from the timing mechanism, the amount of each fill is generally set to be somewhat excessive. If the nominal fill volume settings are not excessive, too little water would be added for the pump to operate properly in some installations. The excess amount of water added during each fill multiplies for each wash phase during a complete wash cycle, which can become a significant factor in water usage. Further, because a large amount of the energy consumed by a dishwasher is used to heat the fill water, this excessive water use also has a significant impact on the amount of energy required to operate the dishwasher.

A somewhat similar issue in dishwasher design is encountered in the drain phase during operation. Because the amount of back pressure or drain head that will be encountered by the machine when installed is unknown at the time of manufacture, the amount of time the drain pump is energized must be set to a maximum value to ensure that all of the water is pumped out. This maximum value setting is required even in installations with a high drain head (e.g., a situation in which there is relatively high back pressure on the drain line causing slow draining of the water). Because of the maximum value setting, the drain pump runs longer than required in most operations to ensure that all of the water is evacuated from the dishwasher. This excess drain time lengthens the overall cycle and generates noise as the drain pump continues to run after emptying the entire tub of water, without water necessary to keep it primed.

Since one of the significant energy inputs of a dishwasher is the amount of energy used to heat the wash water, it would be preferable to be able to precisely control the temperature of the water inside the dishwasher. Present systems use a preset heat setting and do not measure the temperature of the water as the cycle progresses. It could be advantageous to monitor and maintain this temperature at a constant level without over- or undershooting the desired temperature.

Another method used in conventional systems to control the water fill volume is to utilize the performance of the wash pump. These systems measure the amount of air drawn into the system and the load on the pump as a function of the amount of air drawn into the system. The presence of air bubbles in pump operation indicates that insufficient liquid has been added to the system to keep the pump primed and that the water inlet valve should remain open in order to provide more water. Still other fill level control systems utilize the turbidity in the water as a measure of whether a full fill level has been reached. For example, one prior art system uses a fill level sensor to stop the filling of the washer and to calculate a fill rate of water. This type of sensor is termed a single fill level sensor.

### SUMMARY OF THE INVENTION

The present invention overcomes the disadvantages of the prior art fill level control systems by providing an apparatus and method for monitoring the level of water within the dishwasher for each wash phase. In addition, the fill level control system can further include a temperature sensing device, preferably a thermistor, to monitor the water temperature and to provide a signal to a controller to allow maintenance of a constant temperature for each wash phase. This temperature controller allows the temperature of wash phases to be individually and independently controlled.

The present invention generally utilizes a mast type structure which protrudes vertically from a point near the bottom of the dishwasher sump. Sensors are distributed along the length of the mast. Each of these sensors is sensitive to water, or other liquid, and provides a signal when the liquid level reaches the sensor. The signal is then transmitted to the dishwasher microprocessor system, which opens or closes the water control valve in response to these signals. The height of each of these sensors relative to one another and to the bottom of the sump is pre-configured. Because the precise shape of the sump is known, the precise volume of water present in the machine is known when the water level reaches each one of the known heights corresponding to the height of the sensors. As the water fills the machine and the level of water rises to submerge each sensor, the conductivity of the water completes the circuit between the sensor and a microprocessor. When the microprocessor detects that the water level has reached a particular sensor along the vertical length of the mast, the water volume is known at that time.

Another benefit of the present design is that when water is being pumped out of the machine during the drain phase, the microprocessor can detect level changes as the water volume decreases. When the water level reaches the bottom of the sump, the drain phase is terminated. Thus, the lower portion of the mast has a sensor that is spaced substantially apart from the other sensors and that determines the end of the drain cycle as the water reaches the bottom of the sump.

Another aspect of the invention is the inclusion of a temperature sensor on the mast, which is preferably a thermistor that provides a temperature reading to the dishwasher controller. The thermistor is preferably in a location where it is surrounded by turbulent wash water and is in close proximity to an electrical sensor connection. The mast is provided at a location where the influence of outside air temperature is minimal and the exposure to turbulent wash water is maximum. Because of its location, the thermistor's temperature reading more accurately represents the true temperature of the wash water and allows a signal to be generated from the dishwasher controller to turn heating elements on and off inside the dishwasher. Thus, the energy utilization for heating water can be optimized.

### BRIEF DESCRIPTION OF THE DRAWINGS

FIG. 1 is a schematic side view of a cutaway portion of a dishwasher.

FIG. 2 is an elevation side view of the mast portion in a cutaway format.

FIG. 3 is a side view of the mast portion.

### DETAILED DESCRIPTION OF A PREFERRED EMBODIMENT

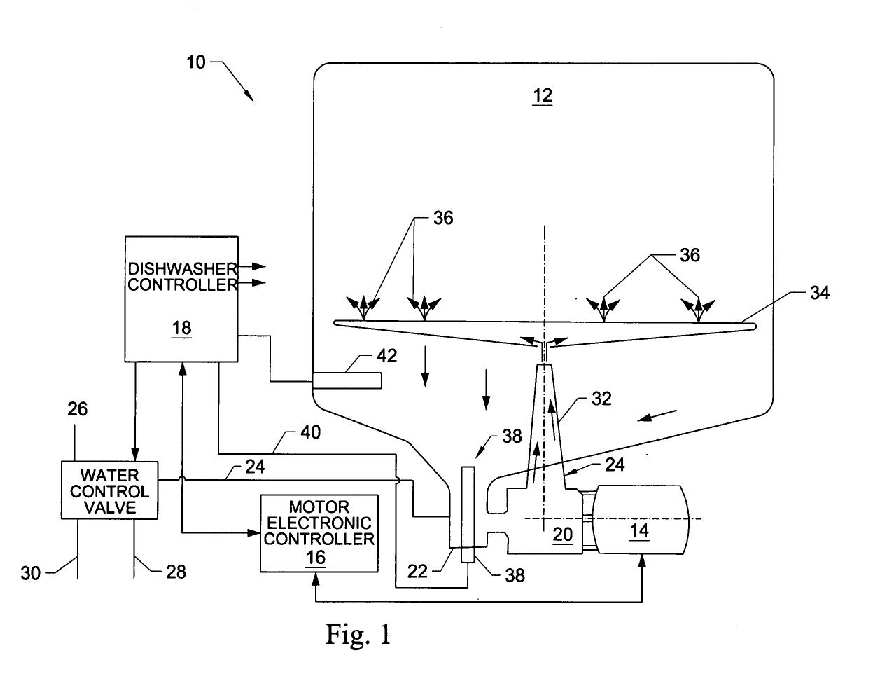

FIG. 1 illustrates a dishwasher 10 that includes a dishwasher tub 12 that is capable of receiving dishes and trays (not shown). The dishwasher 10 includes a motor 14 which drives a pump 20. The motor 14 is connected to a motor controller 16, which in turn is connected to a dishwasher controller 18. The dishwasher controller 18 serves as a cycle timer for the dishwasher 10 and controls all of its operating aspects. The dishwasher 10 includes a sump portion 22, which generally is positioned at the lowest part of the dishwasher tub 12. Water is supplied to the sump 22 through a water inlet line 24 which is connected to a water control valve 26. The water control valve 26 is connected to, and controlled by, the dishwasher controller 18. The water control valve 26 has a water inlet line 28 and a water outlet line 24 that takes the fresh inlet water from the inlet valve to the dishwasher 10. Generally, the water control valve 26 is a conventional electrically controlled valve that is switched from water being supplied to the dishwasher 10 to shutting off fresh water to the dishwasher 10 under the control of the dishwasher controller 18. Water is supplied to the dishwasher 10 through the water inlet line 24 and begins to fill the sump portion 22 of the dishwasher. At some point in the fill cycle, the motor 14 turns on to operate the pump 20. The pump 20 supplies water under pressure through an inlet tower 32 to a spray arm 34, which houses a plurality of discharge water jets 36. This general mode of operation describes conventional operation of a dishwasher. However, the fill level control system of the present invention provides a manner of operation different from the prior art.

The fill level sensor array 38 of the present invention is positioned in the sump portion 22 of the dishwasher 10. The fill level sensor array 38 is connected through appropriate wiring 40 to the dishwasher controller 18. The fill level sensor array 38 monitors the level of water in the dishwasher 10 and sends a signal to the dishwasher controller to turn the water control valve 26 on and off as a function of the monitored water level. In addition to the water level sensors, the sensor array 38 includes a temperature sensor that is also connected through the wiring system 40 to the dishwasher controller. The dishwasher controller in turn controls a heating element 42, contained within the dishwasher 10, to raise the water temperature within the dishwasher 10.

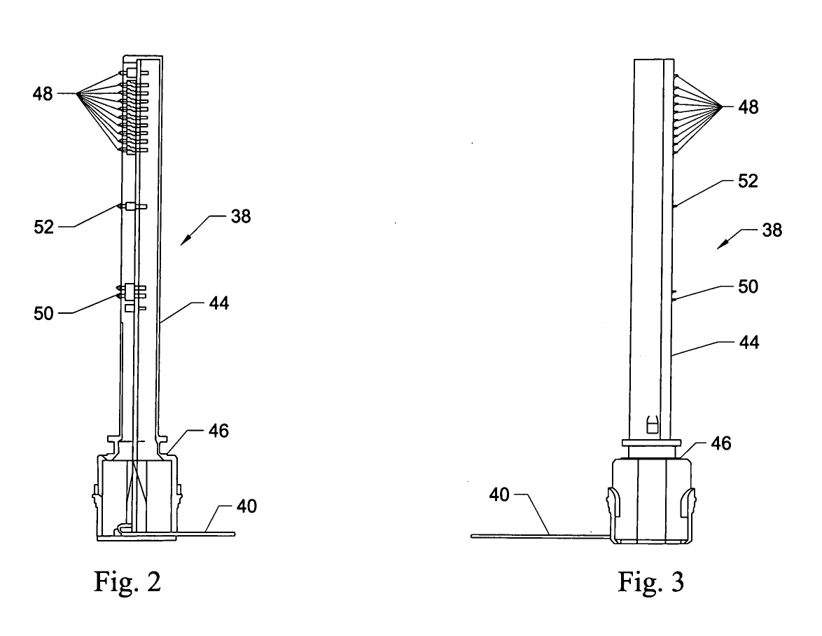

The structure and configuration of the fill level sensor array 38 can be best understood in FIGS. 2 and 3. In FIG. 2, the sensor array 38 is shown in a cutaway section to understand its general configuration. The sensor array 38 is mounted in a hollow, mast like member 44. The mast member 44 extends upwardly from the sump portion 22 of the dishwasher as shown in FIG. 1. An O-ring groove 46 is provided to allow a watertight seal between the sump 22 and the mast member 44. A plurality of sensors 48 are mounted within the mast member 44 near its upper portion. While the number of sensors 48 is dependent upon the number of different fill volumes called for during an entire wash cycle, a minimum of two of these sensors 48 should be provided, one at least for water fill volume and one near the bottom of the sump (shown at sensor 50) to indicate if the sump has drained completely of water. In the present illustration, a total of nine sensors 48 are provided. This allows a flexible control strategy for a dishwasher with a number of wash phases to allow for a wide range of soil conditions of the dishes placed in the dishwasher.

All of these sensors 48 have their leads bundled into a cable that runs the length of the mast member 44. This bundle of leads then is connected through the wiring 40 to the dishwasher controller 18. In addition to the sensors 48, which control the upper level or the high level of fill in a dishwasher, a single low level sensor 50 is positioned near the lower portion of the mast 44. The low level sensor 50 is designed to measure when the sump 22 has been emptied substantially. In this manner, a separate drain pump 60 can be shut off without operating for an inordinate time or creating excessive noise. The drain pump 60 removes water from the dishwasher through a drain line 61 and discharges it through discharge line 62. A heat sensing device 52 is also contained within the mast 44. The heat sensing device 52 is preferably a thermistor which provides a measure of the water temperature within the dishwasher 10. This thermistor allows adjustment of the water temperature during wash phases. The heat sensing element thus provides a signal to the dishwasher controller 18 and allows optimum control of the temperature for any wash phase. As with the sensors 48 and 50, the heat sensing device 52 has leads bundled into the wiring 40, which are connected to the dishwasher controller 18.

FIG. 3 shows the fill level sensor array in its completed form prior to insertion into the dishwasher 10. Because of the hostile environment in which the sensor array 40 operates, the mast portion 44 is a hollow member with holes in its exterior surface to allow the sensors 48, 50, and 52 to extend into the interior of the dishwasher 10. To protect this arrangement, the interior of the mast member 40 preferably is filled with epoxy, or, as the term is used in the art, the components are “potted.” This potting protects all of the components from the effects of water and the caustic detergents used in the dishwasher. However, the portion of the sensors that are exposed have been selected to be durable to survive in this hostile environment. Potting or encapsulating the remainder of the components allows electrical contact to be maintained during the life of the dishwasher 10. As seen in FIG. 3, the sensors 48, 50, and 52 project from the side of the mast member to be in contact with the water in the sump portion 22 of the dishwasher 10.

The fill level control system of the present invention has been described for operation with a dishwasher 10. It should be clear that this general type of control system could be utilized with other article washing devices. For example, industrial parts washers that use solvent or chemical based solutions to wash parts also utilize multiple cycles. The fill level control system of the present invention could be used in such an environment to control and ensure that the proper level is present for each washing cycle. In addition, some clothes washing machines have multiple cycles, somewhat analogous to those of a dishwasher. The fill level control system of the present invention could be used in a clothes washing machine as well to determine the level of water for each cycle. The temperature sensing and control functions of the present invention likewise could be used in other article washing devices. While a heater has been shown in the present embodiment, it should be understood that some working devices might require cooling of the operating liquid. Thus, the control systems could act on the temperature signals received to either heat or cool, as required.

While the invention has been disclosed in its preferred form, it will be apparent to those skilled in the art that many modifications, additions, and deletions can be made without departing from the spirit and scope of the invention or its equivalents as set forth in the following claims.

We claim:

1. A control system for an article washing device comprising:
an inlet liquid control valve;
a source of liquid connected through said inlet control valve;
a sensor array positioned in said article washing device, said sensor array having at least one probe member capable of detecting at least one discrete liquid level condition and generating a signal as a function of liquid level; and
a controller that interconnects said inlet control valve and said sensor array and that initiates and ceases flow of said liquid in response to signals received from said sensor array.

2. The control system of claim 1 wherein said article washing device includes a motor driven pump and wherein said control system further includes:
a low level sensor, positioned on said sensor array, for detecting when all of said liquid has been pumped out of said article washing device by said pump and generating a signal in response, said low level sensor being connected to said controller, said controller turning off said motor in response to a signal from said low level sensor.

3. The control system of claim 1 wherein said sensor array is mounted on a vertically extending, mast like member.

4. The control system of claim 3 wherein said sensor array is encapsulated within said mast with selected portions of said sensor array being exposed to said liquid.

5. The control system of claim 1 further including a temperature sensor connected to said controller for generating a temperature signal corresponding to the temperature of the liquid in said article washing device.

6. The control system of claim 5 wherein the article washing device further includes a temperature control device, controlled by said controller for maintaining a desired temperature of the liquid.

7. A dishwasher having variable water level for multiple wash cycle phases comprising:
a controller, including preset phase controls;
an inlet water control valve connected to said controller;
a source of water connected through said inlet control valve; and
a sensor array positioned in said dishwasher and connected to said controller, said sensor array having at least one probe member placed to detect at least one discrete water level condition for at least one discrete wash cycle phase, and to generate a signal as a function of said water levels, whereby said inlet water control valve is turned on and off by said controller in response to signals from said probes.

8. The dishwasher of claim 7 further including a motor driven pump and further including:
a low level sensor, positioned on said sensor array, that detects when all of the water has been pumped out of said dishwasher by said pump and generating a signal in response thereto, said low level sensor being connected to said controller, and said controller turning off said motor in response to a signal from said low level sensor.

9. The dishwasher of claim 7 wherein said sensor array is mounted on a vertically extending mast like member.

10. The dishwasher of claim 9 wherein said mast like member is positioned in a sump portion of said dishwasher.

11. The dishwasher of claim 9 wherein said sensor array is encapsulated within said mast with selected portions of said sensor array being exposed to water.

12. The dishwasher of claim 7 further including a temperature sensor, connected to said controller, for generating a signal corresponding to the temperature of the water in said dishwasher.

13. The dishwasher of claim 12 further including a heating element controlled by said controller for maintaining a desired temperature in said dishwasher.

14. A method for controlling a fill point of a multiple wash phase dishwasher comprising:
supplying water to said dishwasher;
positioning a sensor array in said dishwasher, said sensor array including a plurality of vertically spaced, water responsive probes;
generating a signal by one of said probes when a water level for a pre-selected one of multiple wash phases reaches said probe; and
terminating supply of the water to said dishwasher in response to said signal.

15. The method of claim 14 further comprising:
removing water from said dishwasher at the end of a selected wash phase with an emptying pump;
sensing completion of water removal of said selected wash phase with a low level probe positioned near a lower portion of said sensor array;
generating a signal by said low level probe; and
terminating operation of said emptying pump in response to said signal.

16. The method of claim 14 further comprising:
heating the water in said dishwasher with a heating element;
generating a signal corresponding to a temperature of the water in said dishwasher with a temperature probe mounted on said sensor array; and
controlling the heating element to conform to a pre-selected condition of said multiple wash phases using the signal generated by said temperature probe.

17. A method for controlling a fill point of an article washing device comprising:
controlling operation of said device with a controller having a plurality of pre-selected cycles;
supplying a liquid to said device;
positioning a sensor array in said device, said sensor array including a plurality of spaced apart, liquid sensitive probes;
generating a signal by one of said probes when the liquid level for one of said pre-selected cycles reaches said probe; and
terminating supply of liquid to said device in response to said signal.

18. The method of claim 17 further comprising:
removing liquid from said device at the end of a cycle;
sensing completion of liquid removal from said device with a low level, liquid sensitive probe positioned near a lower portion of said sensor array;
generating a signal by said low level probe;
transmitting said signal to said controller; and
terminating removal of the liquid in response to said signal.

19. The method of claim 17 wherein said article washing device includes a liquid temperature control means and wherein said method further comprises:
generating a signal corresponding to a temperature of the liquid in said device with a temperature probe mounted on said sensor array; and
adjusting the temperature of said liquid using said temperature control means and said signal generated by said temperature probe to maintain a pre-selected temperature.
